(19) United States
(12) Patent Application Publication
(10) Pub. No.: US 2018/0341878 A1
(43) Pub. Date: Nov. 29, 2018

(54) USING ARTIFICIAL INTELLIGENCE AND MACHINE LEARNING TO AUTOMATICALLY SHARE DESIRED DIGITAL MEDIA

(71) Applicant: Get Attached, Inc., New York, NY (US)

(72) Inventors: Albert Azout, Palo Alto, CA (US); Douglas Imbruce, New York, NY (US); Gregory T. Pape, New York, NY (US)

(21) Appl. No.: 15/607,026

(22) Filed: May 26, 2017

(51) Int. Cl. G06N 99/00; G06N 3/00

(52) U.S. Cl. CPC G06N 99/005; G06N 3/004

(57) ABSTRACT

Artificial intelligence is utilized to automatically share a digital media. The digital media is detected. The media is analyzed using machine learning to identify whether the digital media is likely not desirable to share. In an event the digital media is not identified as not desirable to share, the digital media is automatically shared.

### BACKGROUND OF THE INVENTION

Traditional media sharing services require a user to manually determine which photos to share. Typically the user manually reviews an album of photos taken by the user and manually selects each photo to be shared with another specified user. Often the photos to be shared are attached in a text message or an email message and sent to the recipient user. This is often a cumbersome process that may discourage and impede sharing of important captured moments that the user would have otherwise liked to have shared. For example, a user may forget to share an important photo or may be discouraged from sharing due to the amount of required effort.

### BRIEF DESCRIPTION OF THE DRAWINGS

Various embodiments of the invention are disclosed in the following detailed description and the accompanying drawings.

FIG. 1 is a block diagram illustrating an example of a communication environment between a client and a server for automatically sharing desired digital media.

FIG. 2 is a functional diagram illustrating a programmed computer system for automatically sharing desired digital media in accordance with some embodiments.

FIG. 3 is a flow diagram illustrating an embodiment of a process for automatically sharing desired digital media.

FIG. 4 is a flow diagram illustrating an embodiment of a process for classifying digital media.

FIG. 5 is a flow diagram illustrating an embodiment of a process for the creation and distribution of a machine learning model.

FIG. 6 is a flow diagram illustrating an embodiment of a process for automatically sharing desired digital media.

FIG. 7 is a flow diagram illustrating an embodiment of a process for applying a context-based machine learning model.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatically sharing desired digital media (e.g., photo, video, etc.) is disclosed. For example, using artificial intelligence/machine learning, digital media likely not desired to be shared (e.g., includes nudity) is identified and not automatically shared while other digital media classified as likely desired to be shared is automatically shared with approved contacts (e.g., shared with spouse).

In some embodiments, a user has a collection of digital media, such as photos and/or videos, on a smartphone device. The media is analyzed using machine learning and artificial intelligence. In some embodiments, the analysis classifies the media into categories on the smartphone device. As an example, the media may be classified by using a machine learning model and running inference on the media on the device. Examples of categories may include media classified as documents (e.g., photo of documents, credit cards, etc. not desirable to share), screenshots (e.g., photo of screen capture not desirable to share), private (e.g., photo with nudity not desirable to share), and approved for sharing. Based on the machine learning and artificial intelligence analysis, the media may be marked as desirable for sharing or not desirable for sharing. For example, the media may be marked based on the identified categories. Media not marked as not desirable to share are automatically shared with approved contacts. In an example with media that is photos, photos are classified into categories of documents, screenshot, private, and approved. Photos that are documents and private are marked as not desirable for sharing. Photos classified as approved are marked as desirable for sharing and shared with approved contacts.

As additional media is created, the new media is analyzed using machine learning and artificial intelligence. The analyzed media is then marked as desirable or not desirable for sharing based on the analysis. In some embodiments, the analysis using machine learning and artificial intelligence determines one or more categories associated with the media and the media is marked based on the identified categories. The media not marked as not desirable for sharing is then automatically shared. This process of detecting, analyzing and marking for sharing desirability, and uploading desirable for sharing media proceeds without manual user interaction and may be performed in a background process. In some embodiments, only media not marked for not sharing is uploaded to the media hosting service while media identified as not desirable for sharing remains safely stored on the smartphone device. For example, photos marked for not desirable for sharing, such as documents and private photos, remain on the smartphone device.

In another embodiment, the photos on a smartphone device may be uploaded as a partial or entire set to a media hosting service, such as an online backup or cloud storage service. The media on the media hosting service is classified into categories by applying machine learning to the media stored at the media hosting service. Based on the identified category, the media is automatically shared with approved contacts. Only media marked for sharing is automatically shared. Media that is not marked for sharing is uploaded to the media hosting service but not automatically shared.

In some embodiments, digital media is automatically shared by identifying the media that the user likely does not desire to share. For example, digital media is detected on a device. The detected media is analyzed on the device using machine learning to identify whether the digital media is likely not desirable to share. For example, recent photos on a smartphone device are detected and analyzed using a deep neural network multi-classifier. The analysis classifies each of the recent photos into categories, where one or more of the categories, such as documents and private photos, are not desirable for sharing. The photos that are not identified as not desirable to share are automatically shared. For example, photos that are classified as not documents and not private are classified as approved. Approved photos are automatically uploaded to a media sharing service and shared with approved contacts. In some embodiments, the detection of new media, the analysis and marking of the new media, and the uploading of approved media may be performed in a background process and occurs automatically without active user participation. In some embodiments, the detection of new media, the analysis and marking of the new media, and the uploading of approved media may be performed in a process or thread in the foreground but without active user participation. In some embodiments, the foreground application is a multi-threaded application for viewing automatically shared media. For example, the application allows the user to view the media the user has automatically shared with others as well as the media that other users have automatically shared with the user.

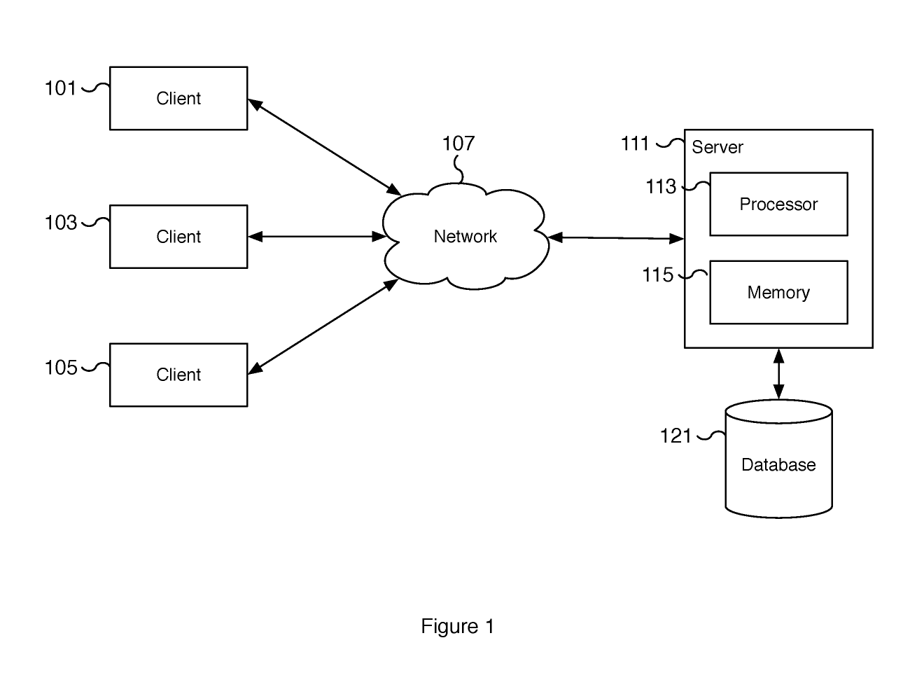

FIG. 1 is a block diagram illustrating an example of a communication environment between a client and a server for automatically sharing desired digital media. In the example shown, clients 101, 103, and 105 are network computing devices with media for sharing and server 111 is a digital media sharing server. Examples of network computer devices include but are not limited to a smartphone device, a tablet, a laptop, a virtual reality headset, an augmented reality device, a network connected camera, a gaming console, and a desktop computer. Clients 101, 103, and 105 are connected to server 111 via network 107. Examples of network 107 include one or more of the following: a mobile communication network, the Internet, a direct or indirect physical communication connection, a Wide Area Network, a Storage Area Network, and any other form of connecting two or more systems, components, or storage devices together.

Users of clients 101, 103, and 105 generate digital media such as photos, videos, interactive scenes in virtual worlds, etc. For example, client 101 may be a smartphone device that a user creates photos and videos with by using the smartphone's camera. As photos and videos are taken with client 101, the digital media is saved on the storage of client 101. The user of client 101 desires to share only a selection of the digital media on the device without any interaction by the user of client 101. Some photos and videos may be private and the user does not desire to share them. As an example, the user may not desire to automatically share photos of documents, which may include photos of financial statements, personal records, credit cards, and health records. As another example, the user may not desire to automatically share photos that contain nudity. In another example, the user may not desire to automatically share screenshot images/photos.

In the example shown, users of clients 101, 103, and 105 selectively share their digital media with others automatically based on sharing desirability. The media generated by clients 101, 103, and 105 is automatically detected and analyzed using a machine learning model to classify the detected media into categories. Based on the identified category, media is marked for sharing and automatically uploaded through network 107 to server 111 for sharing. In some embodiments, the classification is performed on the client such as on clients 101, 103, and 105. For example, a background process detects new media, such as photos and videos, as they are created on a client, such as client 101. Once detected, a background process automatically analyzes and classifies the media. A background process then uploads the media marked as desirable for sharing to a media sharing service running on a server such as server 111. In some embodiments, the detection, analysis and marking, and uploading process may be performed as part of the media capture processing pipeline. For example, a network connected camera may perform the detection, analysis and marking, and uploading process during media capture as part of the processing pipeline. In some embodiments, the detection, analysis and marking, and uploading process may be performed by an embedded system. In some embodiments, the detection, analysis and marking, and uploading process may be performed in a foreground application. In various embodiments, server 111 shares the shared media with approved contacts. For example, server 111 hosts the shared media and makes it available for approved clients to interact with the shared media. Examples of interaction may include but are not limited to viewing the media, zooming in on the media, leaving comments related to the media, downloading the media, modifying the media, and other similar interactions. In some embodiments, the shared media is accessible via an application that runs on a client, such as on clients 101, 103, and 105, that retrieves the shared media from server 111. Server 111 uses processor 113 and memory 115 to process, store, and host the shared media. In some embodiments, the shared media and associated properties of the shared media are stored and hosted from database 121.

In some embodiments, client 101 contains an approved list of contacts for viewing shared media that includes client 103 but does not include client 105. For example, photos automatically identified by client 101 for sharing are automatically uploaded via network 107 to server 111 for automatic sharing. Once shared, the shared photos are accessible by the originator of the photos and any contacts on the approved list of contacts. In the example, client 101 and client 103 may view the shared media of client 101. Client 105 may not access the shared media since client 105 is not on the approved list of contacts. Any media on client 101 classified as not desirable for sharing is not uploaded to server 111 and remains only accessible by client 101 from client 101 and is not accessible by clients 103 and 105. The approved list of contacts may be maintained on a per user basis such that the list of approved sharing contacts of client 101 is configured based on the input of the user of client 101. In some embodiments, the approved list of contacts may be determined based on device, account, username, email address, phone number, device owner, corporate identity, or other similar parameters. In some embodiments, the shared media may be added to a profile designated by a media publisher. In some embodiments, the profile is shared and/or made public.

In some embodiments, the media on clients 101, 103, and 105 is automatically detected and uploaded via network 107 to server 111. Once the media is uploaded to server 111, server 111 automatically analyzes the uploaded media using a machine learning model to classify the detected media into one or more categories. Based on an identified category, media is marked for sharing and automatically made available for sharing on server 111. For example, client 101 detects all generated media and uploads the media via network 107 to server 111. Server 111 performs an analysis on the uploaded media and, using a machine learning model, classifies the detected media into media approved for sharing and media not for sharing. Server 111 makes the media approved for sharing automatically available to approved contacts configured by client 101 without any interaction required by client 101.

In various embodiments, the components shown in FIG. 1 may exist in various combinations of hardware machines. Although single instances of components have been shown to simplify the diagram, additional instances of any of the components shown in FIG. 1 may exist. For example, server 111 may include one or more servers for hosting shared media and/or performing analysis of detected media. Components not shown in FIG. 1 may also exist.

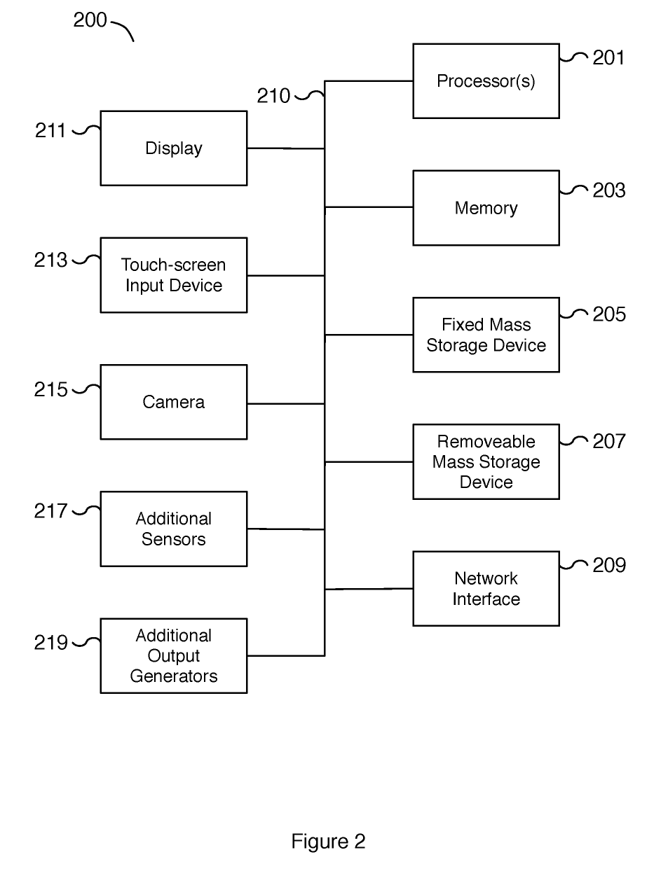

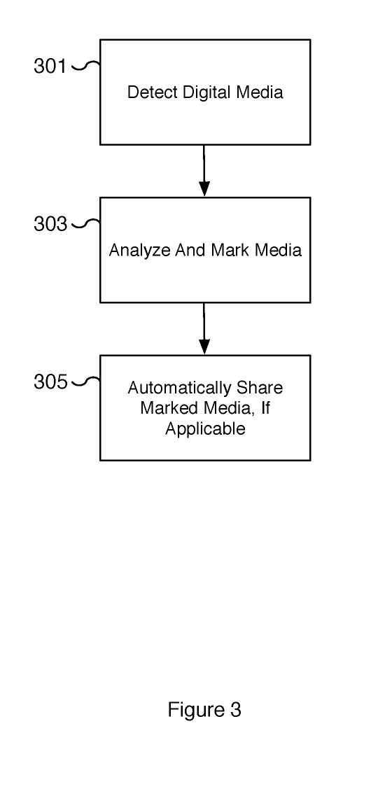

FIG. 2 is a functional diagram illustrating a programmed computer system for automatically sharing desired digital media in accordance with some embodiments. As will be apparent, other computer system architectures and configurations can be used to perform automatic sharing of desired digital media. Computer system 200, which includes various subsystems as described below, includes at least one microprocessor subsystem (also referred to as a processor or a central processing unit (CPU)) 201. For example, processor 201 can be implemented by a single-chip processor or by multiple processors. In some embodiments, processor 201 is a general purpose digital processor that controls the operation of the computer system 200. In some embodiments, processor 201 may support specialized instruction sets for performing inference using machine learning models. Using instructions retrieved from memory 203, the processor 201 controls the reception and manipulation of input data, and the output and display of data on output devices (e.g., display 211). In some embodiments, processor 201 includes and/or is used to provide functionality for sharing desired digital media including detecting new digital media, analyzing and marking media for sharing desirability, and uploading desirable for sharing media. In some embodiments, processor 201 includes and/or is used to provide elements 101, 103, 105, and 111 with respect to FIG. 1 and/or performs the processes described below with respect to FIGS. 3, 4, 5, 6, and 7.

Processor 201 is coupled bi-directionally with memory 203, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 201. Also as is well known in the art, primary storage typically includes basic operating instructions, program code, data, and objects used by the processor 201 to perform its functions (e.g., programmed instructions). For example, memory 203 can include any suitable computer-readable storage media, described below, depending on whether, for example, data access needs to be bi-directional or uni-directional. For example, processor 201 can also directly and very rapidly retrieve and store frequently needed data in a cache memory (not shown).

A removable mass storage device 207 provides additional data storage capacity for the computer system 200, and is coupled either bi-directionally (read/write) or uni-directionally (read only) to processor 201. For example, storage 207 can also include computer-readable media such as flash memory, portable mass storage devices, magnetic tape, PC-CARDS, holographic storage devices, and other storage devices. A fixed mass storage 205 can also, for example, provide additional data storage capacity. Common examples of mass storage 205 include flash memory, a hard disk drive, and an SSD drive. Mass storages 205, 207 generally store additional programming instructions, data, and the like that typically are not in active use by the processor 201. Mass storages 205, 207 may also be used to store digital media captured by computer system 200. It will be appreciated that the information retained within mass storages 205 and 207 can be incorporated, if needed, in standard fashion as part of memory 203 (e.g., RAM) as virtual memory.

In addition to providing processor 201 access to storage subsystems, bus 210 can also be used to provide access to other subsystems and devices. As shown, these can include a display 211, a network interface 209, a touch-screen input device 213, a camera 215, additional sensors 217, additional output generators 219, and as well as an auxiliary input/output device interface, a sound card, speakers, a keyboard, additional pointing devices, and other subsystems as needed. For example, the additional sensors 217 may include a location sensor, an accelerometer, a heart rate monitor, and/or a proximity sensor, and may be useful for interacting with a graphical user interface and/or capturing additional context to associate with digital media. As other examples, the additional output generators 219 may include tactile feedback motors, a virtual reality headset, and augmented reality output.

The network interface 209 allows processor 201 to be coupled to another computer, computer network, or telecommunications network using one or more network connections as shown. For example, through the network interface 209, the processor 201 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 201 can be used to connect the computer system 200 to an external network and transfer data according to standard protocols. For example, various process embodiments disclosed herein can be executed on processor 201, or can be performed across a network such as the Internet, intranet networks, or local area networks, in conjunction with a remote processor that shares a portion of the processing. Additional mass storage devices (not shown) can also be connected to processor 201 through network interface 209.

An auxiliary I/O device interface (not shown) can be used in conjunction with computer system 200. The auxiliary I/O device interface can include general and customized interfaces that allow the processor 201 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above and magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 2 is but an example of a computer system suitable for use with the various embodiments disclosed herein. Other computer systems suitable for such use can include additional or fewer subsystems. In addition, bus 210 is illustrative of any interconnection scheme serving to link the subsystems. Other computer architectures having different configurations of subsystems can also be utilized.

FIG. 3 is a flow diagram illustrating an embodiment of a process for automatically sharing desired digital media. In some embodiments, the process of FIG. 3 is implemented on clients 101, 103, and 105 of FIG. 1. In some embodiments, the process of FIG. 3 is implemented on server 111 of FIG. 1. In some embodiments, the process of FIG. 3 occurs without active participation or interaction from a user.

In the example shown, at 301, digital media is automatically detected. For example, recently created digital media, such as photos or videos newly taken, is detected for processing. As another example, digital media that has not previously been analyzed at 303 (as discussed below) is detected. In some embodiments, the detected media is stored on the device. In some embodiments, the detected media is live media, such as a live video capture. In some embodiments, the live media is media being streamed. As an example, a live video may be a video conference feed. In some embodiments, the live video is streamed and not stored in its entirety. In some embodiments, the live video is divided into smaller chunks of video which are saved on the device for analysis.

At 303, the detected digital media is automatically analyzed and marked. The analysis of digital media is performed using machine learning and artificial intelligence. In some embodiments, the analysis using machine learning and artificial intelligence classifies the detected media into categories. For example, a machine learning model is trained using a corpus of photos from multiple categories. The training results in a machine learning model with trained weights. Inference is run on each detected media to classify it into one or more categories using the trained multi-classifier. Categories may include one or more of the following: approved, documents, screenshots, unflattering, blurred, gruesome, medically-oriented, and private, among others. In some embodiments, private media is media that may contain nudity. In some embodiments, the analysis classifies the media into a single category. In some embodiments, the analysis classifies the media into more than one categories. In some embodiments, the output of a multi-classifier is a probability distribution across all categories. In some embodiments, different thresholds may exist for identifying whether a media belongs to a particular category. For example, in the event that the analysis is tuned to be more sensitive to nudity, a threshold for classification for nudity may be lower than the threshold for documents. In some embodiments, the output of classification is further analyzed, for example, by using one or more additional stages of machine learning and artificial intelligence. In some embodiments, one or more additional stages of machine learning and artificial intelligence are applied prior to classification. For example, image recognition may be applied using a machine learning model prior to classification. In various embodiments, the identified categories determine if the analyzed media is desirable for sharing. As an example, the categories documents and private may not be desired for sharing. In some embodiments, the remaining categories that are not marked not desired for sharing are approved for sharing. The analyzed media is automatically marked for sharing or not for sharing based on classification. In some embodiments, all digital media captured and/or in specified folder(s) or album(s) is to be automatically shared unless specifically identified/classified as not desirable to share.

At 305, the analyzed digital media is automatically shared, if applicable. For example, in the event the media is not marked for not desirable for sharing, it is automatically shared. For example, in the event the media is marked as not desirable for sharing, it is not uploaded for sharing with specified/approved contact(s) and other media (e.g., all media captured by user device or all media in specified folder(s) or album(s)) not marked as not desired for sharing) is automatically shared. In some embodiments, despite a digital media being not identified/marked as not desirable to share, a user may manually identify/mark the media as not desirable to share and this media is not automatically shared. In some embodiments, a media that has been automatically shared may be removed from sharing. For example, the user that automatically shared the media may apply an indication to no longer share the media. In another example, in the event the media is marked desirable to share, it is automatically shared. For example, only media specifically identified/marked using machine learning as desirable for sharing is automatically shared. In some embodiments, despite a digital media being identified/marked as not desirable to share, a user may manually identify/mark the media as desirable to share and this media is automatically shared.

In some embodiments, if the media is marked for sharing, it is automatically uploaded to a media sharing server such as server 111 of FIG. 1 over a network such as network 107 of FIG. 1. In some embodiments, the uploading of media for sharing is performed as a background process without user interaction. In various embodiments, the uploading is performed in a process that is part of a foreground application and that does not require user interaction. In various embodiments, the media is shared with approved contacts. For example, an approved contact may receive a notification that newly shared media from a friend is available for viewing. The approved contact may view the shared media in a media viewing application. In another example, the newly shared media will appear on the devices of approved contacts at certain refresh intervals or events. In some embodiments, prior to automatically sharing the media, the user is provided a message or indication that the media is going to be automatically shared (e.g., after a user configurable time delay) and unless otherwise instructed by the user, the media is automatically shared. For example, a user is provided a notification that twelve recently taken photos are going to be automatically shared after a time delay period of ten minutes. Within this time delay period, the user has the opportunity to preview the photos to be automatically shared and instruct otherwise to not share indicated one(s) of the photos.

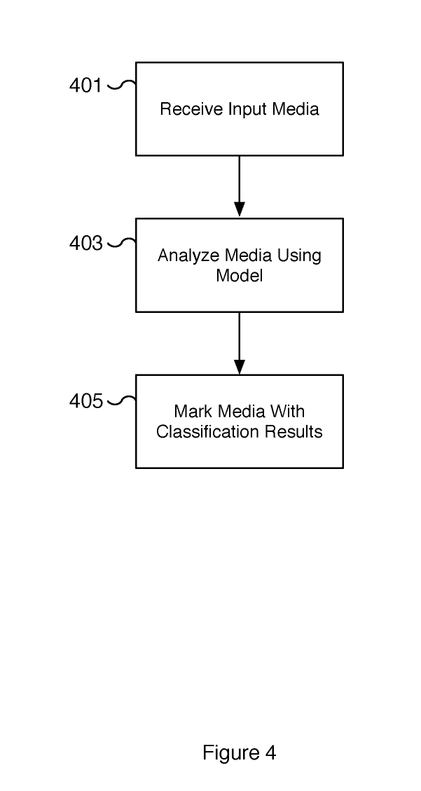

FIG. 4 is a flow diagram illustrating an embodiment of a process for classifying digital media. In some embodiments, the process of FIG. 4 is implemented on clients 101, 103, and 105 of FIG. 1. In some embodiments, the process of FIG. 4 is implemented on server 111 of FIG. 1. In some embodiments, the process of FIG. 4 is performed at 303 of FIG. 3.

In the example shown, at 401, digital media is received as input for classification. For example, a computer process detects the creation of new digital media and passes the new digital media to be received at 401 for classification. In some embodiments, once received, the digital media may be validated. For example, the media may be validated to ensure that it is in the appropriate format, size, color depth, orientation, and sharpness, among other things. In some embodiments, no validation is necessary at 401. In some embodiments, at 401, as part of receiving the digital media, data augmentation is performed on the media. In some embodiments, data augmentation may include applying one or more image processing filters such as translation, rotation, scaling, and skewing. For instance, the media may be augmented using scaling and rotation to create a set of augmented media for analysis. The analysis of each augmented version of media may result in a different classification score. In some scenarios, multiple classification scores are used for classifying a media. In some embodiments, data augmentation includes batching media to improve the computation speed. In some embodiments, validation may take place at 301 of FIG. 3 in the process of detecting digital media.

At 403, a digital media is analyzed and classified into categories. In some embodiments, the result of classification is a probability that the media belongs to one or more categories. In some embodiments, the result of classification is a vector of probabilities. In some embodiments, the classification uses one or more machine learning classification models to calculate one or more values indicating a classification for the media. For example, an input photo is analyzed using a multi-classifier to categorize the photo into one or more categories. Categories may include categories for media that are not desirable for sharing. As an example, a document category and a private category may be categories not desirable for sharing. The document category corresponds to photos identified as photos of documents, which may contain in them sensitive or confidential information. The private category corresponds to photos that may contain nudity. In some embodiments, photos that are not classified into categories not desired for sharing are classified as approved for sharing.

In some embodiments, prior to 403, a corpus of media is curated with multiple categories. In some embodiments, the corpus is human curated. In some embodiments, the categories include approved, documents, and private, where the approved category represents desirable for sharing media. A machine learning model is trained on the corpus to classify media into the identified categories. In some embodiments, the categories are revised over time. In some embodiments, the machine learning model is a deep neural net multi-classifier. In some embodiments, the deep neural net multi-classifier is a convolutional neural network. In some embodiments, the convolutional neural network includes one or more convolution layers and one or more pooling layers followed by a classification, such as a linear classifier, layer.

At 405, the media is marked based on the classification results. Based on the classified categories, the media is automatically identified as not desirable for sharing or desirable for sharing and marked accordingly. For example, if the media is classified to a non-desirable to share category, the media is marked as not desirable for sharing. In some embodiments, the remaining media may be classified as approved for sharing and marked for sharing. In some embodiments, the media is classified into an approved category and is marked for sharing.

In some embodiments, a video is classified by first selecting individual frames from the video. Determining the frames of the video may be performed at 401. The frames are processed into images compatible with the machine learning model of 403 and classified at 403. The output of the classified frames at 403 is used to categorize the video. In 405, the video media is marked as desirable for sharing or not desirable for sharing based on the classification of the frames selected from the video. In some embodiments, if any frame of the video is classified into a category not desirable for sharing then the video is marked as not desirable for sharing. In some embodiments, the frames selected are memorable frames of the video. In some embodiments, memorable frames are based on identifying memorable events or actions in the video. In some embodiments, memorable frames may be based on the number of individuals in the frame, the individuals identified in the frame, the location of the frame, audio analyzed from the frame, and/or similarity of the frame to other media such as shared photos. In some embodiments, memorable frames may be based on analyzing the audio of a video. For example, audio analysis may be used to recognize certain individuals speaking; a particular pattern of audio such as clapping, singing, laughing, etc.; the start of dialogue; the duration of dialogue; the completion of dialogue; or other similar audio characteristics. In some embodiments, the frames selected are based on the time interval the frames occur in the video. For example, a frame may be selected at every fixed interval. As an example, in the event the set fixed time interval is five seconds, a frame is extracted from the video every five seconds and analyzed for classification. In some embodiments, the frames selected are key frames. In some embodiments, the frames selected are based on the beginning or end of a transition identified in the video. In some embodiments, the frames selected are based on the encoding used by the video. In some embodiments, the frames selected include the first frame of the video.

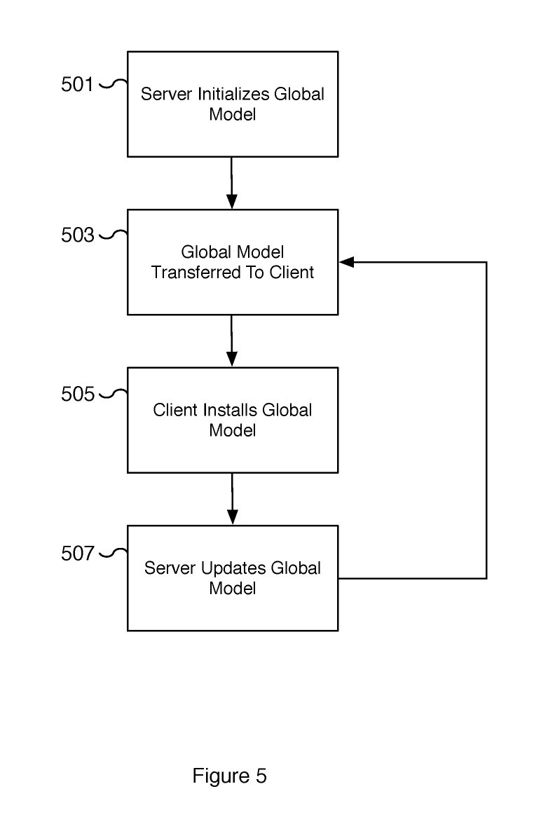

FIG. 5 is a flow diagram illustrating an embodiment of a process for the creation and distribution of a machine learning model. In some embodiments, the process of FIG. 5 is implemented on clients 101, 103, and 105 and server 111 of FIG. 1. In some embodiments, the client described in FIG. 5 may be any one of clients 101, 103, and 105 of FIG. 1 and the server described in FIG. 5 is server 111 of FIG. 1. In some embodiments, the client and the server are separate processes that execute on the same physical server machine or cluster of servers. For example, the client and server may be processes that run as part of a cloud service. In some embodiments, the process of 503 may be performed as part of or prior to 301 and/or 303 of FIG. 3.

In the example shown, at 501, a server initializes a global machine learning model. In some embodiments, the initialization includes the creation of a corpus and the model weights determined by training the model on the corpus. In some embodiments, the data of the corpus is first automatically augmented prior to training. For example, in some embodiments, image processing techniques are applied on the corpus that provide for a more accurate model and improve the inference results. In some embodiments, image processing techniques may include rotating, scaling, and skewing the data of the corpus. In some embodiments, motion blur is removed from the images in the corpus prior to training the model. In some embodiments, one or more different forms of motion blur are added to the corpus data prior to training the model. The result of training with the corpus is a global model that may be shared with multiple clients who may each have his or her unique set of digital media.

At 503, the global model including the trained weights for the model is transferred to a client. For example, a client smartphone device with a camera for capturing photos and video installs a media sharing application. As part of the application, the application installs a global model and corresponding trained weights. In some embodiments, the model and appropriate weights are transferred to the client with the application installation. In various embodiments, once the application is installed, the application fetches the model and appropriate weights for download. In some embodiments, weights are transferred to the client when new weights are available, for example, when the global model has undergone additional training and new weights are determined. In some embodiments, once the model architecture is determined and model weights are trained, the model and weights are converted to a serialized format and transferred to the client. For example, the model and weights may be converted to serialized structured data for download using a protocol buffer.

At 505, the client installs the global model received at 503. For example, a serialized representation of the model and weights is transferred at 503 and unpacked and installed at 505. In some embodiments, a version of the global model is used by the client for inference to determine media desired for sharing. In some embodiments, the output of inference on detected media, additional context of the media, and/or user preferences based on the sharing desirability of media are used to refine the model and model weights. For example, in some embodiments, a user may mark media hidden to reflect the media as not desirable for sharing. The hidden media may be used to modify the model. In some embodiments, the additional refinements made by clients are shared with a server. In some embodiments, only information from media desired for sharing is shared with the server. In this manner, any non-sharable data remains on the client. In some embodiments, contextual information of detected media, as described in additional detail below, is shared with the server. In some embodiments, a server receives additional information to improve the model and weights. In some embodiments, an encoded version of media not desirable for sharing is used to improve the model. In some embodiments, the encoding is a one-way function such that the original media can not be retrieved from the encoded version. In this manner, media not desirable for sharing may be used to improve the model without sharing the original media.

At 507, the server updates the global model. In some embodiments, the corpus is reviewed and new weights are determined. In some embodiments, the model architecture is revised, for example, by the addition or removal of convolution or pooling layers, or similar changes. In some embodiments, the additional data received by clients is fed back into the model to improve inference results. In some embodiments, decentralized learning is performed at the client and partial results are synchronized with the server to update the global model. For example, one or more clients may adapt the global model locally. The adapted global models are sent to the server by clients for synchronization. The server synchronizes the global model using the client adapted models to create an updated global model and weights. The result of 507 may be an updated model and/or updated model weights.

In the event the global model is updated at 507, at 503, the updated global model is transferred to the client. In various embodiments, the model and/or appropriate weights are refreshed at certain intervals or events, such as when a new model and/or weights exist. As an example, a client is notified by a silent notification that a new global model is available. Based on the notification, the client downloads the new global model in a background process. As another example, a new global model is transferred when a media sharing application is in the foreground and has determined that a model update and/or updated weights exist. In some embodiments, the update occurs automatically without user interaction.

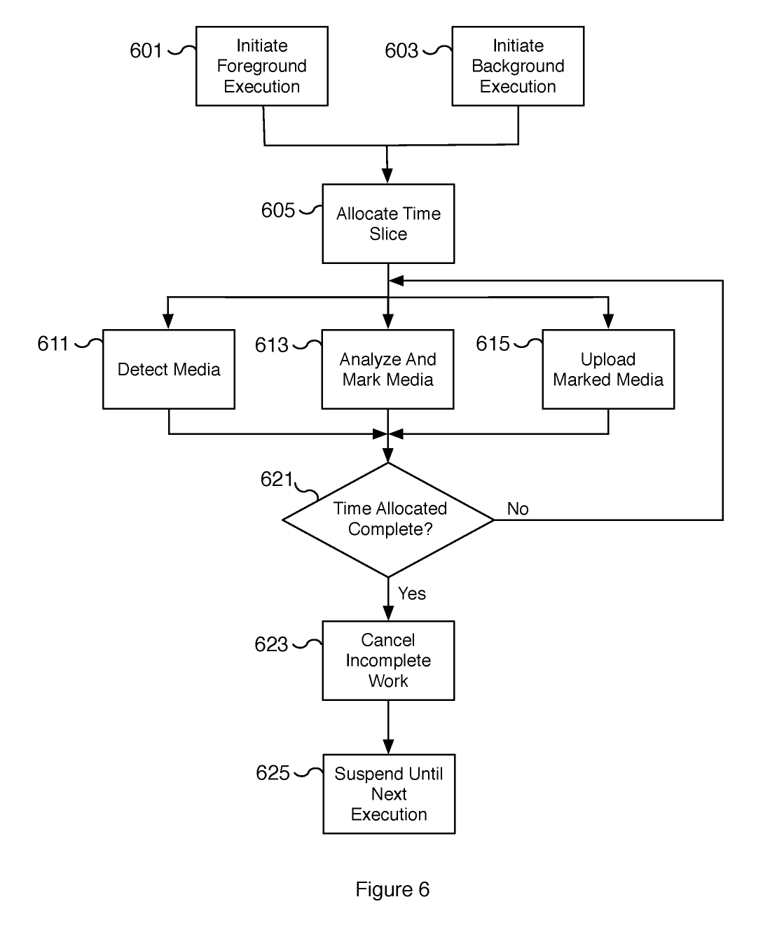

FIG. 6 is a flow diagram illustrating an embodiment of a process for automatically sharing desired digital media. In some embodiments, the process of FIG. 6 is implemented on clients 101, 103, and 105 of FIG. 1. In some embodiments, the process of FIG. 6 is implemented on a server machine, such as server 111 of FIG. 1, or a cluster of servers that run as part of a cloud service. In some embodiments, the process of FIG. 6 is performed by a media sharing application running on a mobile device.

In the example shown, the initiation of automatic sharing of desired digital media can be triggered from either a foreground process at 601 or a background process at 603. At 601, an application running in the foreground initiates the automatic sharing of desired digital media. For example, a user opens a media sharing application that may be used for viewing and interacting with shared digital media. In some embodiments, the foreground process initiates automatic sharing of desired digital media. In various embodiments, the foreground application creates a separate process that initiates automatic sharing of desired digital media.

At 603, background execution for automatic sharing of desired digital media is initiated. In some embodiments, the background execution is initiated via a background process. In various embodiments, background execution is triggered by an event that wakes a suspended application. In some embodiments, events are monitored by the operating system of the device, which wakes a suspended application when system events occur. In some embodiments, background execution is triggered by a change in location event. For example, on some computer systems, an application can register to be notified when the computer system device changes location. For example, in the event a mobile device transitions from one cell tower to another cell tower, a change of location event is triggered. As another example, in the event a device's change in location exceeds a threshold, as determined using a location system such as a global positioning system, a change of location event is triggered. In the event a change in location event occurs, a callback is triggered that executes background execution for automatic sharing of desired digital media. As an example, a change in location event results in waking a suspended background process and granting the background process execution time.

In some embodiments, background execution is triggered when a notification event is received. When a notification arrives at a device, a suspended application is awoken and allowed background execution. When a notification is received, a callback is triggered that executes background execution for automatic sharing of desired digital media. In some embodiments, notifications are sent at intervals to trigger background execution for automatic sharing of desired digital media. In some embodiments, the notifications are silent notifications and initiate background execution without alerting the user. In some embodiments, the sending of notifications is optimized for processing the automatic sharing of desired digital media, for example, by adjusting the frequency and/or timing notifications are sent. In some embodiments, notification frequency is based on a user's expected behavior, history, location, and/or similar context. For example, in the event a user frequently captures new media during Friday evenings, notifications may be sent more frequently during that time period. As another example, in the event a user frequently captures new media when the user's location and/or media location are identified as a restaurant, notifications may be sent more frequently in the event the user's location is determined to be at a restaurant. As another example, in the event a user rarely captures new media during sleeping hours, notifications may be sent very infrequently or disabled during those hours.

In some embodiments, background execution is triggered when a system event occurs. As an example, in the event a device comes into WiFi range, the device may switch from a cellular network to a WiFi network and initiate a change in network connectivity event. In some embodiments, in the event a device connects to a WiFi network, a callback is triggered that executes background execution for automatic sharing of desired digital media. As another example, a system event may include when a device is plugged in for charging and/or connected to a power supply. In some embodiments, the execution in 601 and 603 is performed by threads in a multi-threaded system instead of by a process.

Execution initiated by a foreground process at 601 and execution initiated by a background process at 603 proceed to 605. At 605, execution for automatic sharing of desired digital media is triggered from 601 and/or 603 and a time slice for processing the automatic sharing of desired digital media is allocated. In some embodiments, the time slice is allocated by setting a timer. In some embodiments, the duration of the timer is tuned to balance the processing for the automatic sharing of desired digital media with the operation of the device for running other applications and services. In some embodiments, the duration of the timer is determined based on an operating system threshold and/or monitoring operating system load. For example, the duration is set such that the system load for performing automatic sharing of desired digital media is below a threshold that the operating system determines would require terminating the automatic sharing process. In some embodiments, the process for automatic sharing of desired digital media includes monitoring system resources and adjusting the timer accordingly. In various embodiments, the time slice may be determined based on a queue, a priority queue, process or thread priority, or other similar techniques.

Once a time slice has been allocated in 605, at 611, digital media is detected. For example, new and/or existing digital media on the device is detected and prepared for analysis. In some embodiments, only unmarked digital media is detected and analyzed. For example, once the detected digital media is analyzed, it is marked so that it will not be detected and analyzed on subsequent detections. In some embodiments, a process is run that fetches any new digital media, such as photos and/or videos that were created, taken, captured, or otherwise saved onto the device since the last fetch. In some embodiments, the process of 611 is performed at 301 of FIG. 3.

Once a time slice has been allocated in 605, at 613, detected digital media is analyzed and marked based on the analysis. In some embodiments, the digital media that is analyzed is the media detected at 611. In the example shown, the analysis uses machine learning techniques that apply inference on the new media detected. The inference is performed on the client device and classifies the media into categories. Based on the classification, the media is marked as desirable for sharing or not desirable for sharing. In some embodiments, the process of 613 is performed at 303 of FIG. 3.

Once a time slice has been allocated in 605, at 615, media that has been detected, analyzed, and marked as desirable for sharing is uploaded to a digital media sharing server. In some embodiments, additional metadata of the media desirable for sharing is also uploaded. For example, additional metadata may include information related to the output of inference on the digital media such as classified categories; properties of the media including its size, color depth, length, encoding, among other properties; and context of the media such as the location, camera settings, time of day, among other context pertaining to the media. In some embodiments, the media and any additional metadata are serialized prior to uploading. In some embodiments, the process of 615 is performed at 305 of FIG. 3.

In some embodiments, the processes of 611, 613, and 615 may be run in separate stages in processes (or threads) simultaneously and output from one stage may be shared with another stage via inter-process communication. For example, the newly detected media from 611 may be shared with the process of 613 for analysis via inter-process communication. Similarly, the media marked desirable for sharing from 613 may be shared via inter-process communication with the process of 615 for uploading. In some embodiments, the processing of 611, 613, and 615 is split into chunks for batch processing. In some embodiments, the stages of 611, 613, and 615 are run sequentially in a single process.

At 621, the time slice allocated in 605 is checked for completion. In the event the time slice has completed, execution proceeds to 623. In the event the time slice has not completed, processing at 611, 613, and 615 resumes until the time slice completes and/or the time slice is checked at 621 again. In this manner, the processing at 611, 613, and 615 may be performed in the background while a user interacts with the device to perform other tasks. In some embodiments, in the event the processing at 611, 613, and 615 completes prior to the time slice completing, the processes at 611, 613, and 615 may wait for additional data for processing. The execution of 621 follows from the execution of 611, 613, and 615. In some embodiments, the process of 621 is triggered by the expiration of a timer set in 605.

In the event that the time slice allocated for the processing of automatic sharing of desired digital media has completed in 621, at 623, any incomplete work is cancelled. Incomplete work may include work to be performed by 611, 613, and 615. In some embodiments, the progress of work performed by 611, 613, and 615 is recorded and suspended. In the event additional time is later granted, the work performed by 611, 613, and 615 resumes. In various embodiments, the work may be cancelled and in the event additional execution time is granted, previously completed partial work may need to be repeated. For example, in the event inference is run on a photo that has not completed classification, the photo may require repeating the classification analysis when execution resumes.

Once any incomplete work has been cancelled at 623, at 625, the processing for automatic sharing of desired digital media is suspended until the next execution. For example, once the time allocated for processing completes, the process(es) performing the automatic sharing of desired digital media are suspended and placed in a suspended state. In some embodiments, the processes associated with 611, 613, and 615 are suspended. In some embodiments, the processes associated with 611, 613, and 615 are terminated and control returns to a parent process that initiated them. In some embodiments, a parent process performs the processing of 605, 621, 623, and/or 625. In some embodiments, the resources required for the automatic sharing of desired digital media while in a suspended state are minimal and the majority of the resources are reallocated by the system to other tasks.

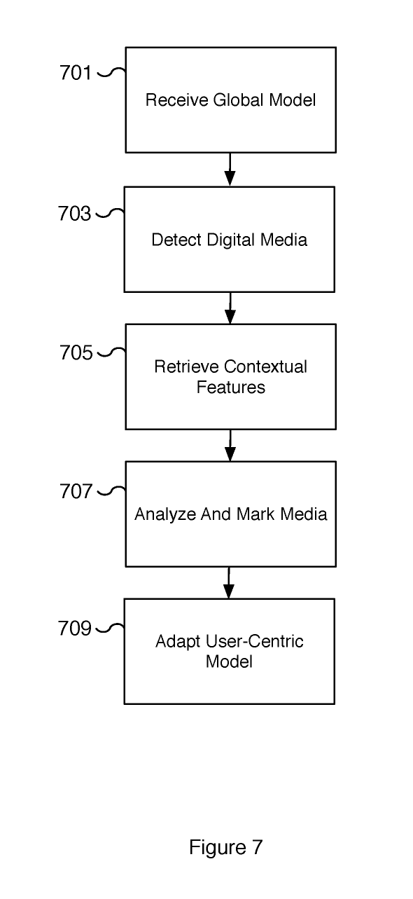

FIG. 7 is a flow diagram illustrating an embodiment of a process for applying a context-based machine learning model. In some embodiments, the process of FIG. 7 is implemented on clients 101, 103, and 105 and server 111 of FIG. 1. In some embodiments, the client and the server are separate processes but are performed on the same physical server machine or cluster of servers. For example, the client and server may be processes that run as part of a cloud service. In some embodiments, the process of FIG. 7 may be performed as part of or prior to 301 and/or 303 of FIG. 3.

In the example shown, at 701, a client receives a global model. For example, a global machine learning model and trained weights are transferred from a server to a client device. In some embodiments, a CNN model is received for running inference on digital media. At 703, digital media is automatically detected for the automatic sharing of desired digital media. For example, newly created media is detected and queued for analysis. At 705, contextual features are retrieved. The contextual features are features related to the context of the digital media and may include one or more features as described herein. In some embodiments, contextual features may be based on features related to the location of the media, recency of the media, frequency of the media, content of the media, and other similar contextual properties associated with the media. Examples of contextual features related to the recency and frequency of media include but are not limited to: time of day, time since last media was captured, number of media captured in a session, depth of media captured in a session, number of media captured within an interval, how recent the media was captured, and how frequent media is captured. Examples of contextual features related to the location of the media include but are not limited to: location of the media as determined by a global positioning system, distance the location of the media is relative to other significant locations (e.g., points of interest, frequently visited locations, bookmarked locations, etc.), distance traveled since the last location update, whether a location is a public place, whether a location is a private place, status of network connectivity of the device, and WiFi connectivity status of the user. Examples of contextual features related to the content of the media include but are not limited to: number of faces that appear in the media, identify of faces that appear in the media, and identification of objects that appear in the media. In some embodiments, the contextual features are based on the machine learning model applied to the media, such the version of the model applied and/or classification scores.

In some embodiments, the contextual features originate from sensors of the device, such as the global positioning system or location system, real-time clock, orientation sensors, accelerometer, or other sensors. For example, the context may include the time of day, the location, and the orientation of the device when the detected digital media of 703 was captured. In some embodiments, the contextual features include context based on similar media or previously analyzed similar media. For example, the location of a photo may be determined to be a public place or a private place based on other media taken at the same location. As an example, video of a football stadium is determined to be a taken in a public place if other media taken at the stadium is characterized as public. As another example, a photo taken in a doctor's office is determined to be taken in a private place if other media taken at the doctor's office is characterized as private.

In some embodiments, a location is determined to be a public place if one or more users shared media from the location previously. In some embodiments, the location is determined to be a private location if the user has previously desired not to share media of the location. As another example, contextual information includes individuals who have viewed similar media and may be interested in the detected media. Additional examples of contextual information based on similar media or previously analyzed similar media include similarity of the media to recently shared or not shared media.

In some embodiments, the contextual features include context within the digital media detected. For example, contextual features may include the identity of individuals in the digital media, the number of individuals (or faces) in the digital media, the facial expressions of individuals in the digital media, and other similar properties. In some embodiments, the contextual features include context received from a source external to the device. As an example, contextual features may include reviews and/or ratings of the location the media was taken. In the scenario that a photo taken at a restaurant is detected, contextual information of the photo may be retrieved from an external data source and may include a rating of the restaurant, sharing preferences of past patrons of the restaurant, and/or the popularity of the restaurant.

After the contextual features at 705 are retrieved, at 707, the detected media is analyzed and marked as not desirable for sharing or desirable for sharing by classifying the detected media in part based on the context. For example, detected media is classified using a context-based model to determine categories for the media. Based on the categories, the media is marked as desirable for sharing or not desirable for sharing. In some embodiments, the specific actions performed at 707 are described with respect to FIG. 4 but using a context-based model. In some embodiments, a context-based machine learning model is trained on a corpus curated using training data that contains context associated with the media and classified into categories. In some embodiments, the categories have an associated desirability for sharing. In some embodiments, the context is used as input into a machine learning model, such as a multi-classifier, where values based on the context are features of the model. In some embodiments, the weighted outputs of a classification layer, such as the final layer of a Convolutional Neural Network layer or an intermediary layer, are combined with the context as features to a linear model. The linear model, such as a Logistic Regression binary classifier, may combine contextual and deep learned features into a input vector which is used for classification. In some embodiments, the deep learned model and linear model are combined into an ensemble learner which may use a weighted combination of both models. In some embodiments, a Meta Learner may be trained to learn both models in combination. In some embodiments, the trained weights based on the contextual features are used to create a model for classification.

Once the detected media has been analyzed for classification and marked as desirable or not desirable for sharing, at 709, a user-centric model may be adapted. In some embodiments, a user-centric model is a context-based model that is personalized to an individual or group of users. For example, a user-centric model is a context-based model that is created or updated based on feedback from a user or group of users. In some embodiments, the user-centric model is based on the results of analysis from 707. In various embodiments, a user-centric model is based on user feedback and combines content features and contextual features. In some embodiments, the user-centric model created or updated in 709 is used for analysis in 707.

In some embodiments a user-centric model is a machine learning model specific to a particular user. In some embodiments, a user-centric model is individualized for a particular user based on the user's feedback. For example, a personalized user-centric model is based on implicit feedback from the user, such as photos a user chooses not to share. In some embodiments, a user-centric model is a machine learning model specific to a group of users and is adapted from a global model. For example, a global model is adapted based on the feedback of a group of users. In some embodiments, the user group is determined by a clustering method.

In various embodiments, the analysis performed at 707 and the user-centric model adapted in 709 are used to revise a global model. For example, a global model is trained and distributed to clients for use in classification. Based on the results of the global model and contextual features of the detected media, a user-centric model is adapted. In some embodiments, the feedback from the global model and/or the user-centric model is used to revise the global model. Once revised, the global model may be redistributed to clients for analysis and additional revision.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for using artificial intelligence to automatically share a digital media, comprising:
detecting the digital media;
analyzing the media using machine learning executed using a processor to identify whether the digital media is likely not desirable to share; and
automatically sharing the digital media in an event the digital media is not identified as not desirable to share.

2. The method of claim 1, wherein the machine learning relies on a context-based model.

3. The method of claim 2, wherein the context-based model includes a location associated with the media.

4. The method of claim 2, wherein the context-based model includes a time associated with the media.

5. The method of claim 1, wherein the machine learning relies on a user-centric model.

6. The method of claim 1, wherein the machine learning relies on a multi-classifier.

7. The method of claim 6, wherein the multi-classifier uses one or more convolution layers and one or more pooling layers.

8. The method of claim 1, wherein automatically sharing the digital media is initiated by a system event.

9. The method of claim 8, wherein the system event is a change in location event.

10. The method of claim 8, wherein the system event is a notification event.

11. The method of claim 8, wherein the system event is a change in network connectivity event.

12. The method of claim 1, wherein analyzing the media using machine learning comprises classifying the media into categories.

13. The method of claim 12, wherein classifying the media includes identifying documents and nudity.

14. The method of claim 1, wherein analyzing the media is performed on a mobile device.

15. The method of claim 1, wherein automatically sharing the digital media not identified as not desirable to share includes uploading the digital media to a photo sharing service.

16. The method of claim 1, further comprising:
receiving a global machine learning model from a server.

17. A method for automatically sharing a digital media, comprising:
initializing a global machine learning model;
transferring the model to a client;
receiving digital media from the client in an event the digital media is not identified as not desirable to share; and
sharing the digital media.

18. The method of claim 17, wherein initializing the global machine learning model includes performing data augmentation on a training data corpus.

19. The method of claim 18, wherein performing the data augmentation includes applying a motion blur.

20. A system for using artificial intelligence to automatically share a digital media, comprising:
a processor; and
a memory coupled with the processor, wherein the memory is configured to provide the processor with instructions which when executed cause the processor to:
detect the digital media;
analyze the media using machine learning to identify whether the digital media is likely not desirable to share; and
automatically share the digital media in an event the digital media is not identified as not desirable to share.
